(19) United States
(12) Patent Application Publication
(10) Pub. No.: US 2009/0216746 A1
(43) Pub. Date: Aug. 27, 2009

(54) Method, System, and Apparatus for Aggregation System for Searchable Travel Data

(76) Inventors: Francois Aubin, Montreal (CA); Jerome Paradis, Montreal (CA); Andrew Zarrow, New York, NY (US)

Correspondence Address: CHADBOURNE & PARKE LLP, 30 ROCKEFELLER PLAZA, NEW YORK, NY, 10112, US

(21) Appl. No.: 12/162,246

(22) PCT Filed: Jan. 25, 2007
(86) PCT No.: PCT/US2007/061079

§ 371 Date: Apr. 27, 2009

Related U.S. Application Data
(60) Provisional application No. 60/762,281, filed on Jan. 25, 2006.

(51) Int. Cl. G06F 17/30

(52) U.S. Cl. 707/5; 707/E17.108; 707/104.1

(57) ABSTRACT

The system may be configured to actively obtain or passively receive charter data objects. The data objects may include information like available charter equipment (e.g., aircraft), availability location and/or time information. The system may be configured to process either a variety for object formats from a variety of data sources. The system extracts charter flight data indicators and corresponding flight characteristics to create and populate a charter flight data record, which serve as the foundation for charter data management system components. The system implements search functionality identifying charter flight data records with a best match or alternate suggested results. Charter flight records originate from multiple sources that are published/distributed in standardized or non-standardized ways. information. The system accepts and stores available flight requests from clients and automatically alert users (i.e.: indirectly through sales representatives or directly to the prospect or customer).

### PRIORITY

This application claims priority under 35 U.S.C. § 119(e) to U.S. Provisional Application Ser. No. 60/762,281, titled “Method, System and Apparatus for Aggregation System for Searchable Travel Data” filed on Jan. 25, 2006.

### FIELD

The present invention is directed generally to apparatuses, methods, and systems for facilitating charter data aggregation and management and more particularly, to an apparatus, method and system for receiving/obtaining charter data elements, processing the elements and facilitating system user searches of the processed charter data.

### BACKGROUND

Conventionally, charter travel providers, such as charter airline flight operators, have published and distributed their equipment availability and fee information. This type of information may be published and/or distributed in a variety of standardized or non-standardized formats. There is a significant need to provide a method, system and apparatus that aggregates the various types of availability data, processes the data and presents it in a format that is easily managed. Furthermore, there is a need to provide a system user with a convenient, effective interface for working with the processed data.

### SUMMARY

The disclosure details the implementation of apparatuses, methods, and systems associated with a Travel Aggregation System. In an implementation the system is configured to aggregate travel availability information, as well as process travel search requests from system users. The system may be configured as an intermediary configured for coordinating the processed data from both entities—a series of travel providers distributing travel data and system users submitting travel availability requests.

The system may be configured to actively obtain or passively receive certain data objects. These data objects may be configured to include availability information for services, such as charter flight availability. The data objects may include information like available equipment (e.g., aircraft), availability location and/or time information. The system may be configured to process either structured/non-structured data objects from system registered charter data sources or non-registered sources.

In a charter flight system configuration, the system extracts charter flight data characteristics from the data objects and uses the data to create and populate a charter flight data record. These data records serve as the underlying foundation for a charter data aggregation management system components. One aspect of data management components involve facilitating a search engine to find available charter flights, which may be configured as one way legs. A roundtrip or a flight with one or more stops in between departure and destination can be expressed as a series of one-way legs.

The system may be configured to implement search engine functionality to identify charter flight data records that provide an initial match or alternate results (alternate available flights that available charter flights that most closely match a requested charter flight criteria. Charter flight records originate from multiple sources that are published/distributed in standardized or non-standardized ways. The system is also populated with source confidence/veracity scores to indicate the confidence in the automated data extraction tool for non-standardized data extraction. The system accepts and stores available flight requests from clients (or participants/community members, if the system is implemented as a service for a community of users) and automatically alert users (i.e.: indirectly through sales representatives or directly to the prospect or customer). The system can be easily integrated into existing software applications to initiate search results, add schedules, retrieve contacts and communicate with other facilities of the system through an application programming interface.

### BRIEF DESCRIPTION OF THE DRAWINGS

The accompanying drawings illustrate various non-limiting, example, inventive aspects in accordance with the present disclosure:

FIG. 1 is a high-level component diagram illustrating aspects of the system components and some of the entities that interact with the system according to an implementation of the system;

FIG. 2 is a high-level flow diagram illustrating aspects of a charter data aggregation and management process according to an implementation of the system;

FIG. 3 is a flow diagram illustrating aspects of charter data aggregation processing in an airline charter flight implementation of the system;

FIG. 4 is an example of a charter data object received by the system;

FIG. 5A-5E illustrate aspects of the charter data object processing process according to an implementation of the system;

FIG. 6 is a flow diagram illustrating aspects of charter data search request management for a charter flight data implementation of the system;

FIG. 7 is an example of a charter data search request received by the system in an airline charter flight implementation of the system;

FIG. 8A-8E illustrate aspects of charter data search request processing according to an implementation of the system;

FIG. 9 is a flow diagram illustrating aspects of search request update processing according to an implementation of the system;

FIGS. 10A-10B illustrate aspects of a textual and a visual search result data interface according to an implementation of the system;

FIG. 11 illustrates aspects of computer systemization associated with an implementation of the system.

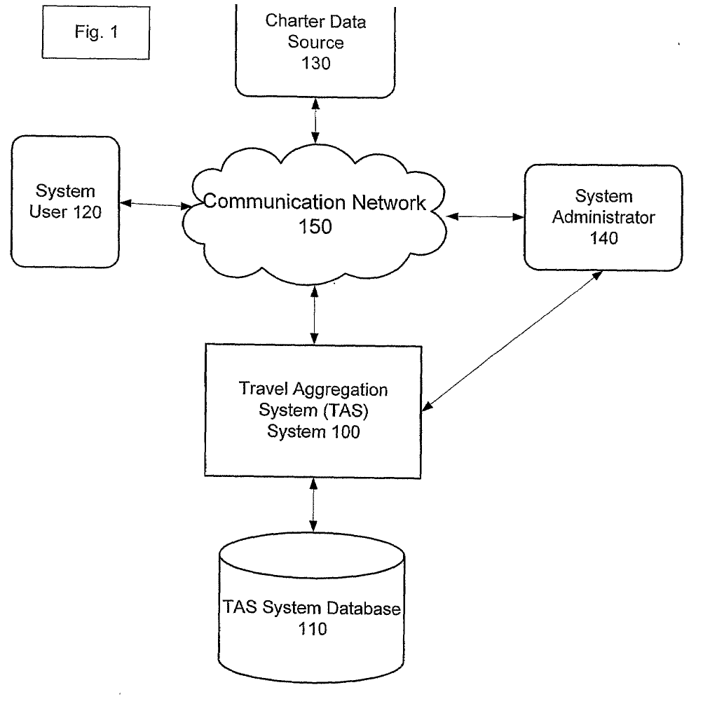

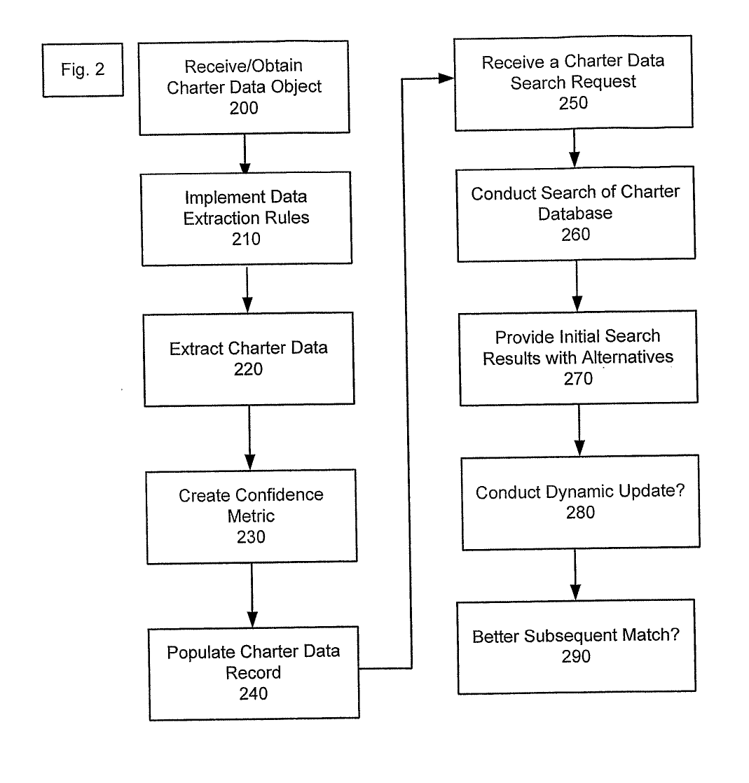

The leading number of each reference number within the drawings indicates the figure in which that reference number is introduced and/or detailed. As such, reference number 101 is first introduced in FIG. 1. Reference number 201 is introduced in FIG. 2, etc.

### DETAILED DESCRIPTION

The system facilitates receiving/obtaining and processing charter data objects that include availability and fee information from a variety of sources, such as travel providers. For the purposes of illustration only in the following figures, the invention will be discussed in an airline context, more specifically as a charter flight data aggregation and processing system. However, it is to be understood that the system, method and apparatus described herein may be adapted to facilitate aggregating and processing any number of different types of data associate with a variety of travel providers and customers. Furthermore, although many aspects of the system are discussed within an airline charter flight context, however, it is to be understood that the system may be configured to meet the needs of a variety of system users beyond a charter flight data implementation discussed herein. For example, the system may be configured to facilitate additional types of travel, freight transportation/shipping, real estate or any number of other implementations that facilitate managing different types of data.

FIG. 1 illustrates a system configuration implemented as a charter data aggregation and processing system or Travel Aggregation System (“TAS”). FIG. 1 illustrates a TAS that includes a primary TAS user interface 100, as well as an underlying TAS system database. As will be described in greater detail below, a system user 120 may use the TAS to find available charter flights (“one legs”) for a user-defined search request detailing charter flight criteria. The TAS system searches the TAS system database for available charter flight records that may originate from a variety of sources 130 depending on the implementation.

The system's travel information database receives data from sources that are non-structured (non-standardized), such as email list-servers or data extracted from scanned advertisements. A system user 120 may navigate the TAS interface individually or with the assistance of a system administrator 140. The system administrator may also work with various charter data sources to coordinate receiving/obtaining charter data objects. Further, the system administrator is also responsible for coordinating the data extraction rules associated with the TAS data object processing modules.

The system 100 accepts and stores available flight requests from system users 120 and in some embodiments may be configured to automatically alert users about additional flight records that provide a better match than initial matches for particular search requests. The system 100 can be easily integrated into existing software applications to initiate search results, add schedules, retrieve contacts and communicate with other facilities of the system through an application programming interface (API).

As illustrated in FIG. 1, the travel aggregation system (“TAS”) 100 may be configured to receive data from a broad range of resources including, resources that distribute standardized charter (“one-legs”) availability information to build travel information database. The standardized data sources 130 generate and transmit data from external systems to the TAS in a range of document formats. This might include XML formatted data, remote accessible databases, well-formatted Web sites and/or emails.

Advantageously, the TAS includes an extensive library of charter object formats that facilitate aggregation of the range of document formats. Additional components of the TAS are configured to receive and process requests for available flights originating from potential customers. The requests may be published from charter data sources. Potential customers can also be referred to the travel aggregate system by customer relationship systems, Web sites and other data entry applications.

Additionally, charter data objects (e.g., available flight data and/or requested flight data) might also be supplied in non-structured digital documents (for example, emails). The TAS is configured to process the text of these documents which are to be semantically/contextually analyzed and an algorithm extracts the charter data records (from available or requested flights). The system may be configured to assign a degree of confidence to these records based on its level of understanding of the information. System administrators work with the TAS to develop a system algorithm based on a multitude of extraction rules to process the data records and populate charter flight data records that are used to populate the TAS system database 110.

The system may be configured with a system data extraction module that parses and extracts charter flights information from non-structured textual digital documents (typically emails) in order to structure the information and populate the TAS database. The extraction module is based on a series rules supplied configured to ‘recognize’ certain features/characteristics of travel availability data. The quantity and quality of the information extracted provides the basis for a degree of confidence metric for a particular source. If the extracted data is suspect, the original extraction document can be displayed to the end-user following a search criterion so that no data is mischaracterized/ignored during processing. Alternately, a suspect document may be purged from the system.

The system may be configured to extract a variety of information from charter data objects. For example, the TAS may be configured to process charter data objects configured as a single digital document might include information about a single or multiple flights with information is published by different sources (publisher). Some sources are well known and publish frequently. Other sources publish less frequently and new sources might be added at any time. The objects may include information such as the charter company; the Company, name, address, phone number, web site and email of contact; the plane type, name, model, etc.; the departure date, availability range of dates; the airport base of departure (name of City, airport name, airport code); and/or the destination (city, region, country, airport name or code).

FIG. 2 illustrates a high-level flow diagram illustrating aspects of TAS data aggregation and management. According to an implementation of the system, the process is initiated when the TAS receives or obtains a charter data object (structured/non-structured flight availability information) in step 200. The TAS retrieves a series of charter data identification and extraction rules in step 210 and extracts the charter flight data characteristics in step 220. Based on the source of the charter data object, as well as the quality of the extracted data characteristics, the TAS derives a data confidence metric 230. The confidence metric provides a system user with assurance that the extracted data corresponds to the availability information from a reputable provider or the flight data characteristics may have been confirmed by a system administrator. The flight data characteristics and confidence metric are then used to populate a charter flight data record in step 240. The charter flight data record is then used to populate TAS database with available flight data.

After the TAS database has been populated, system users may submit a flight data search request in step 250. The flight data search request may be based on three primary flight parameters—requested flight equipment, time and location. The TAS extracts the search parameters and conducts a search of the available charter flight database in step 260. The TAS may be configured to create initial search results that include a best match corresponding to the search request, as well as TAS generated alternate search results that provide alternate suggested results to the system user in step 270. Depending on the implementation, the system may be configured to conduct a dynamic update to the search results. In the dynamic update, the system user may put down a deposit to hold a reservation for the best match. However, for a predetermined reservation period the system may periodically re-conduct the search. In this type of implementation, the TAS may be configured to notify a system user if a better match is identified in one of the subsequent searches in step 290. In some implementations, the system user may be given the opportunity to upgrade to the dynamic search result without penalty.

As discussed, the system attempts to process data looking for certain indicators within a document. For example, charter flight information usually is formatted as a digital document that includes information about a single or multiple flights (an “indicator”). Generally, the information is distributed/published by a variety of sources (publishers). Some sources are well known and publish frequently. Other sources publish less frequently and new sources might be added at any time. Some examples of indicators include: a name of a charter flight operator; company, name, address, phone number, web site and email of contact; a particular plane type, name, model, etc; a departure date, availability range of dates; airport base of departure (name of City, airport name, airport code); and/or a destination (city, region, country, airport name or code). These indicators are simply examples supplied within the charter flight industry. It is to be understood that the invention may be configured and applied to identify indicators associated with other industries, as well as location information associated with worldwide cities, regions, countries, states/provinces, etc.

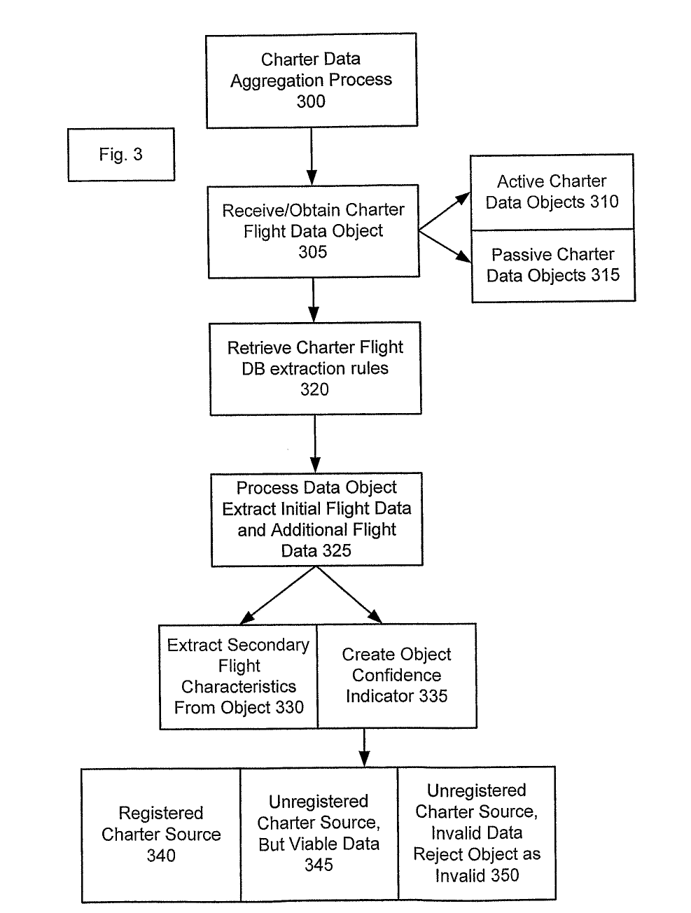

FIG. 3 illustrates aspects of the charter data aggregation process 300 according to an implementation of the TAS. The process is initiated when the TAS receives/obtains a charter flight data object. Based on the implementation, the process may involve passive receipt 315 of data objects or active search 310 data objects. Once the TAS has the data object, the charter data characteristic extraction rules are retrieved in step 320 for processing the data object. The extraction rules are established by a system administrator and may be iteratively refined to focus on certain charter data characteristics. In FIG. 3, the TAS extraction process identifies an initial flight indicator in step 325. As will be discussed in greater detail below, the TAS may coordinate the extraction with any of a number of flight indicators stored in the TAS system database or established by a TAS system administrator. Information about flights is usually received as some type of document (ASCII, HTML, email or fax of a printed availability record). Initially, the TAS may be configured with the following information databases and implement any one or more alone or in combination as keys to correlate an initial flight indicator (i.e., the initial hook into a data object that indicates the object includes viable flight data):
Database of airports, their cities and airport codes
Database of charter plane companies, names and models
Longitude and latitude for all regional information
Database of date formats and date related keywords
Dictionary of relevant indicators or keywords and synonyms.

Once the initial flight indicator is identified, additional flight characteristics associated with the indicator are extracted. Moreover, the TAS may be configured to extract additional flight indicators and any corresponding flight characteristics in step 330. In step 335, the TAS creates an object confidence indicator. In FIG. 3, three possible confidence indicators may be created—a confidence indicator that indicates the underlying source of the data object is a charter source that has registered with the TAS; a confidence indicator that indicates the source is not a registered source, but enough flight data has been extracted to indicate the data is viable; and a confidence indicator that indicates the source is not a registered source and the data is not in a viable data format. If a data object is correlated with this last type of indicator, often the data object will be rejected as invalid, unless a system administrator overrides the TAS. In the context of the TAS, airport routes (one-way legs) detection is the most important information used for aggregation since users will search for flight routes. Even when the confidence of a possible flight object detected during the analysis is very low or the complimentary information (dates, contacts, etc.) are not well detected the TAS can be configured to store these improbable flight routes without elimination. When a user searches for a flight route, many improbable routes are eliminated by the query and results are usually displayed by confidence ranking

The TAS may implement a variety of rules to determine the confidence indicator. For example, some basic rules may include processing the following numbered elements.

1. Content of a Single Flight
Dates must be today or in the future. Some keywords (i.e.: tomorrow) must also be detected as dates
Each possible data fields of a flight record will be searched and identified using formatting rules, keyword proximity rules and the order and number of occurrences of the keyword's appearances

2. Detecting the Presence of One or More Flights in a Document
If there are more than 2 airport codes or names, there is probably more than one flight in the document
Flights come in pairs: departure and destination
When pairs of airports are detected, they may follow industry conventions. If it is the case, scoring will be increased for the detected flight.
Flights have some expected data fields to be valid
Individual records of flights in list of flights are identified through:
   Rules based on the proximity of words identified as flight fields
   The number of occurrences of possible flight record fields occurrences

3. Ranking of the Content
Multiple content rules rank the content based on detected industry keywords, keyword pairs proximity to each order (depending on characters and line breaks), industry specific keywords, pattern matching for common nomenclature and confidence of keywords based on industry vs. non-industry specific usage
Content is ranked based on information supplied by users to the system
Content is also ranked based on accuracy feedback supplied from the expert user
Ranking also depends on past results for similar analyzed content
The recency of a flight record increases its value.

4. Other Rules
If the format of a new document matches the format of a previously received document from the same source, then the degree of confidence in the exactitude of the information will match previous degrees of confidence. If the previous degree of confidence was 100%, then the extraction's exactitude should be 100%.
A library of known formats will be built for formats where most flight record fields can be identified from their variance in multiple occurrences of a format. Differences between different formats can also be determined by the user/developer by identifying pertinent data flight record fields in digital documents.
Templates can also be defined for messages not generated by humans originating from a known and detectable source. For these, flight information can be extracted with 100% confidence and changes to the format can generate alerts to adapt the detection template to future changes.

5. Rejecting Content. if Some Invalid Documents that Contain No Flights are Submitted to the System, they Must be Eliminated or Put Aside without Impacting the Correctness of the System.
Some keywords, like flight codes, have more value in the ranking of pertinent information.
Some keywords, like dates, can have less value if they are not present with other words (flight codes)
Each keyword category will be rated and ranked to establish a scoring to determine if a document should be rejected
If there are only a few basic constituents elements in a document and no flight codes, it is probably not a pertinent document and should be ignored
The same kind of rule can be applied to regions of a document in order to rate regions for relevance. Some ranked text regions can be combined with other ranked text segments and other rules to complement the ranking of a document. For example, flight dates or cities might only be specified once in a document that lists many flights.

The algorithm can detect many flights in a human written message and most of these are invalid. However, these will be filtered out when the score is zero. Additionally, the algorithm will detect possible flights that in reality are invalid. However, these will be filtered out by the following means:
Since users will search for specific flights, for example, for a route between 2 airports, other routes will not be displayed. Therefore, every unusual route a human would not take usually corresponds to an invalidly detected route. Testing and usage of the system has proven that this filters out most of the invalidly detected routes so that those remaining to be displayed are valid or possibly valid.
The search engine will present most relevant match and sort them by scoring. Thus, valid flights will be presented first.
If for a query, some possible flights are displayed, the part of the parsed message corresponding to the flight information is displayed in the search results so that the user can visually and rapidly identify if the flight is valid.

The rules can be adjusted and enriched from user intervention. The user can supply additional content through the addition of an industry context-specific expert system to prioritize its rules and analysis. This user can be a developer or an industry expert that trains the system from numerous available documents. Depending on the needs of a particular system user, the system may be configured to:

1. Verify if all fields matched?

2. Train the system by indicating the fight information for non-matched fields;

3. Identify incorrectly matched fields: for example, the city for a flight arrival or departure could be mistaken with the city of a contact's information;

4. List of preferred and less preferred companies;

5. Flag airports that are never used or rarely needed by the users;

6. List of preferred and less preferred contacts

Based on the confidence scoring assigned to detected flights, user-defined thresholds will help identify flights that are viable, possibly viable and/or invalid.

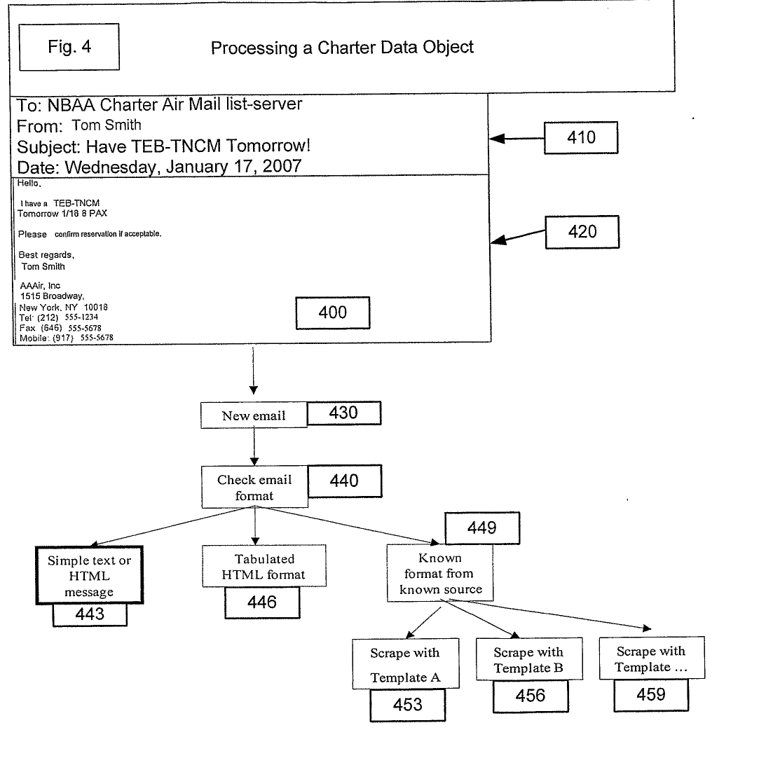

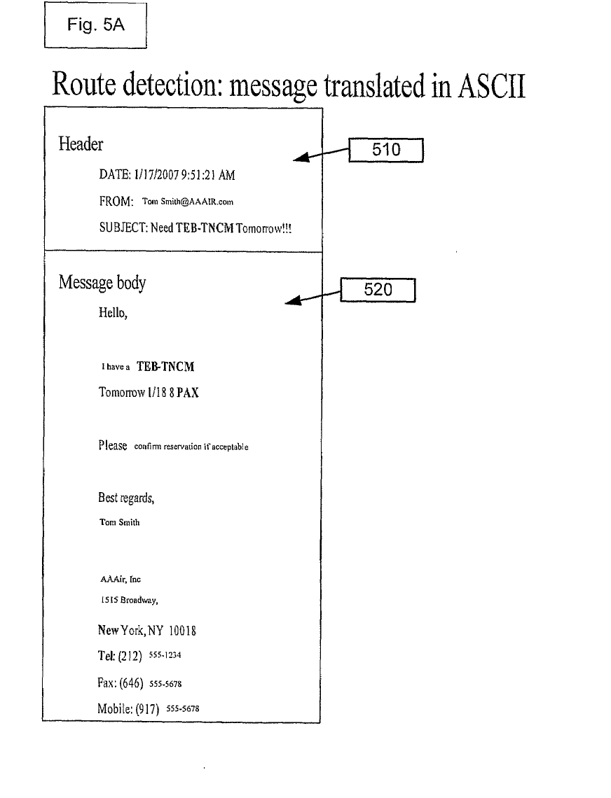

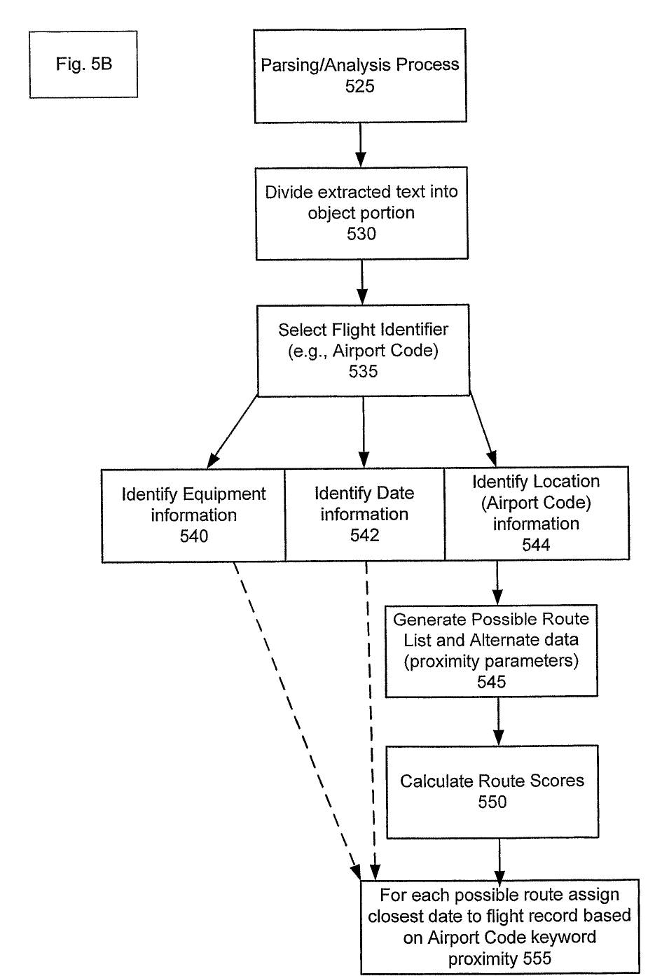

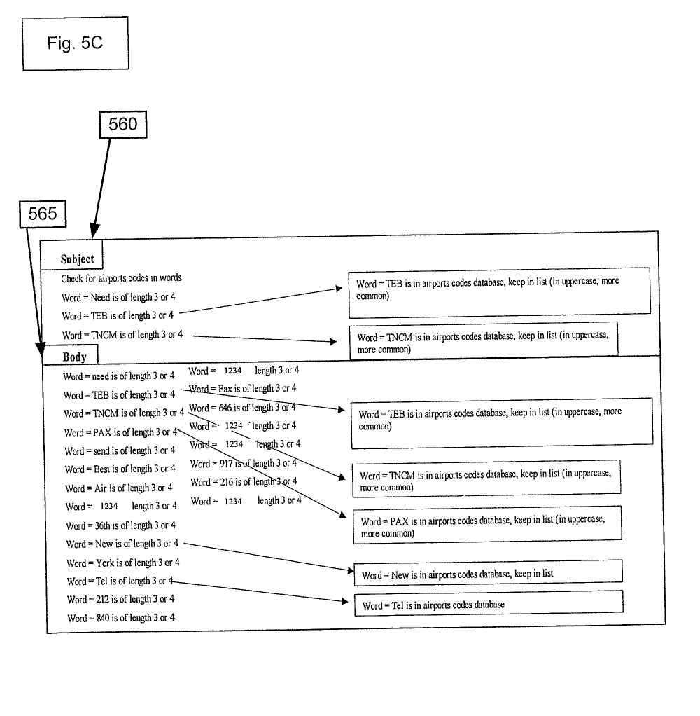

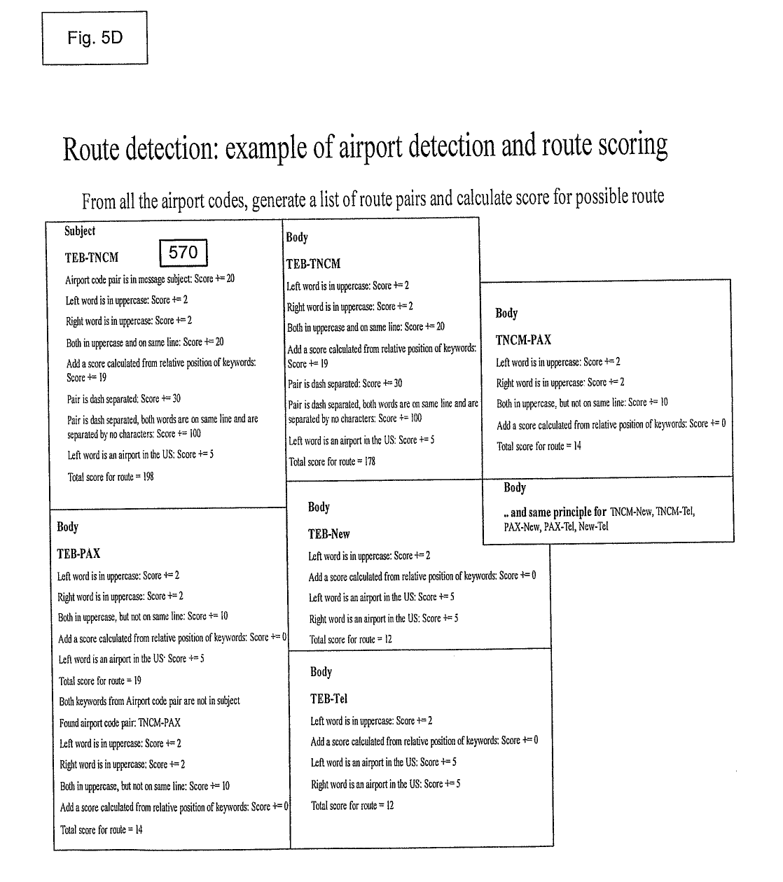

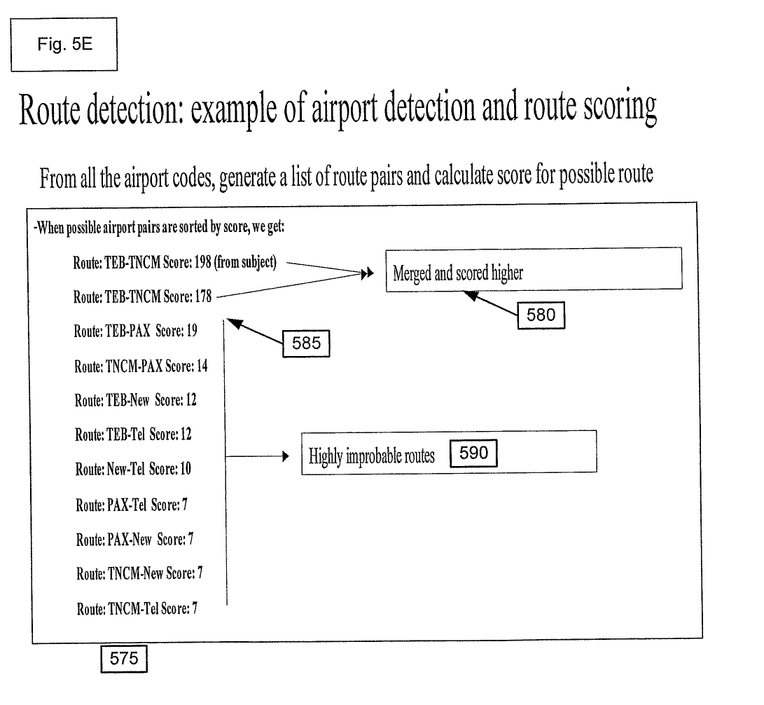

As part of the data confidence check there are several additional situations that may result in the TAS identifying a record as non-viable. It is noted that the travel dates must be for current or future travel. Also, the TAS may be configured to recognize keywords (i.e.: tomorrow) in coordination with the date of the charter object, which may also be used as indicators to complement the flight information with actual dates during data object processing. Each possible data fields of a flight record will be searched and identified using formatting rules, keyword proximity rules and the order and number of occurrences of the keyword's appearances. This process is described in greater detail below with regard to FIGS. 4-5E.

Also, if there are more than 2 airport codes or names, there may be more than one flight in the document. Generally, flights are discussed in pairs corresponding to departure and destination flights. Multiple flights data extraction may also have some expected data qualifiers/identifiers (fields) that establish a system threshold to qualify as a viable charter object. More specifically, individual records of flights in list of flights are identified through a.) rules based on the proximity of words identified as flight fields; and b.) the number of occurrences of possible flight record fields occurrences. The data is ranked (verified) in step 180 based on confidence rules, information supplied to the TAS or on accuracy feedback supplied from the administrator 140 (from FIG. 1A). The TAS may also conduct ranking/verification based on historical results that contain similar analyzed content, as well as how recent the flight date is.

Additional veracity rules include analyzing the document format. If the format of a new document matches the format of a previously received document from the same (verified) source, then the degree of confidence in the exactitude of the information will match previous degrees of confidence. If the previous degree of confidence was 100%, then the extracted data should also be 100%. A library of known formats can be created and maintained for formats where most flight record fields can be identified as variants of stored formats in the TAS system database.

Variants may also be identified by correlating the user/developer by identifying pertinent data flight record fields in digital documents. Moreover, in determining the confidence metric, different parameters may be assigned different weights. Some keywords flight indicators, like airport codes, have more value in the ranking of pertinent information. Some keywords, like dates, can have less value if they are not present with other words (airport codes). Each keyword category will be rated and ranked to establish a scoring to determine if a document should be rejected. If there are only a few basic constituents elements in a document and no flight codes, it is probably not a pertinent document and should be ignored.

The same kind of rule can be applied to regions of a document in order to rate regions for relevance. For example, extracted header information may be weighted more than extracted body information. Also, some ranked text regions can be combined with other ranked text segments and other rules to complement the ranking of a document. For example, flight dates or cities might only be specified once in a document that lists many flights. A system administrator 140 can supplement/enhance/modify or create/delete extraction rules. Alternately, in some embodiments, a user can supply additional content to the expert system to prioritize its rules and analysis. In some implementations an administrator may be a developer or an industry expert that trains the system from numerous available documents. Some possible administrator rules include whether certain/all data fields matched or listing preferred (or excluded) companies and/or contacts.

FIG. 4 illustrates an example of a charter data object that includes flight availability information, whereas FIGS. 5A-5E illustrate aspects of the various processing steps on the example charter data object. In FIG. 4, the charter data object 400 is illustrated with an email format. As discussed above, the TAS may implement a passive charter object search—for example, subscribing to an email list server to receive flight availability information. In FIG. 4, the charter data object is configured as an availability email object 400. The email 400 object may be divided into header information 410 and body information 420. Depending on the implementation, data flight data extracted from one part of the object may be valued differently from data extracted from another part of the email object.

Also, FIG. 4 illustrates aspects of a processing overview for email charter objects. The TAS identifies the charter object as a new email in step 430 and checks for the email format in step 440. Step 440 is an important part of the TAS confidence metric derivation process. As illustrated in FIG. 4, the TAS checks to see if the data object is in simple text format or an HTML message 443, a tabulated HTML format 446 or is identifiable as a known format from a registered source. In the event that the TAS recognizes the object format as from a registered source (449), the TAS may select a stored set of parsing rules that it may use to extract a flight identifier and flight characteristics from the object. For example, the TAS may have templates A (453), B (456) and C(459) that correspond to use with data objects from registered sources A, B and C. These templates are used to create the raw data that is processed in determining whether the object contains viable flight data described below.

FIG. 5A illustrates aspects of the initial processing step when no template 453-459 has been matched to the data object and it has been determined that the message is a simple text or HTML message. Tabulated HTML or other document formats (e.g., word document, pdf, etc.) may be analyzed using similar principle as those described but with differences to account for the various file formats and/or layout of the text within a digital document. The TAS extracts the raw text from the email for processing but maintains two different text portions for analysis—text from header 510 and text from body 520. Once the raw text is extracted, the TAS proceeds with parsing the text to extract possible flight identifiers as illustrated in FIG. 5B. The text parsing/analysis process 525 starts with dividing the raw text into the original object portions for parsing (e.g., header text remains in the header section 510 and body text remains in the body section 520). This partitions may be used later in the analysis to assist in determining the confidence metric. The parsing tool identifies which keyword will serve as a flight identifier for the purposes of an analysis run in step 535. For the purposes of this discussion, the Airport code 544 has been designated as the keyword flight indicator the parser is looking for. It is to be understood however, that depending on the source/type of data object and/or the particular needs of a system user the keyword flight indicator may be designated as date information (542). Equipment information (540) or a number of other parameters that may appear in charter data objects may be used as flight identifier. These other keywords (540, 542) can also be detected, just after step 530 and processed in parallel with the airport code to further assist with the route detection process (535). Accordingly, the steps 535, 540, 542, 544 (branch that includes 545,550) can all be done in parallel and lead to 555. Based on the keyword flight indicator, the TAS then generates a possible route listing and extracts flight characteristics in step 545.

In some implementations, the TAS uses word proximity as a correlation factor in matching flight characteristics with a flight indicator. Once the listing is generated, each possible route is scored according to a scoring template associated with the charter data source/data object in step 550. Once the viable routes are identified, the flight date information and additional flight characteristics are associated with the indicator based on keyword proximity or context in step 555.

FIG. 5C illustrates an example of how the keyword identifier is parsed within the raw text for the two portions of charter data object. In FIG. 5C the keyword identifier is a 3 or 4 letter word Known as the airport code (every airport in the world is associated with a unique airport code, for example LaGuardia Airport in New York city corresponds with LGA). Accordingly, all 3 or 4 letter words are identified in the subject portion 560 and the body portion 565 of the charter object are identified. As shown, words “Need”, “TEB” and “TNCM” qualify as 3 or 4 letter words. These words may then be compared with the airport code database entries held within the TAS system database.

FIG. 5D illustrates aspects of the airport code pairing and scoring process conducted to determine whether the charter object include viable charter flight route information. For example, each of the hits from the previous step (e.g., “TEB” or “TNCM”) is matched with another hit and contextually analyzed to determine a relative score for the proposed route. For example, in FIG. 5D “TEB” and TNCM” are identified and paired for further analysis as a subject pair 570. The analysis is based on adding points to a net score if certain constraints are met.

For example, because the airport code pair is in message subject portion—the proposed route's score is increased by 20 points. Because the each of the left word and the right word in the pair is in uppercase, the route score is increased by 4 points. Furthermore, because both words in the pair are in uppercase and on the same line, the score is increased by an additional 20 points. Generally, the more indicative the characteristic is of an actual flight route, the more the score for the pair is increased. For example, because the pair is separated by a dash, both words are on the same line and there are no other characters separating the pair, the score is increased by 100 points. This feature is highly indicative of a viable route in the context of terminology standards for aviation.

FIG. 5E illustrates aspects of the scoring routine, wherein the score for each proposed pair identified in FIG. 5E is compared. The TAS creates a listing of all possible pairs and its corresponding score 575. If a pair appears in both the subject and the body portions of the record the pair scores are merged. The combined score 580 is used to determine whether the pair qualifies as viable flight data. Depending on the implementation and the scoring rules implemented by the TAS, there is a viability threshold 585 that is the effective cutoff for a pair to qualify as viable flight data. As illustrated in FIG. 5E, flight below the cutoff are designated as highly improbable routes 590. The process may be automated with the system eliminated proposed routes that fall below the threshold or the viable route designation may be achieved visually by a system administrator once all of the routes have been scored.

Furthermore, in some embodiments the system may implement additional filters that exclude proposed pairs where the distance between airports is too short. Alternately, the score may be reduced or eliminated if the airport is too remote, a military airport, or not relevant for the requested/available flight equipment. Date detection may be accomplished by pattern matching, prioritizing patterns, or textual position relative to proposed routes.

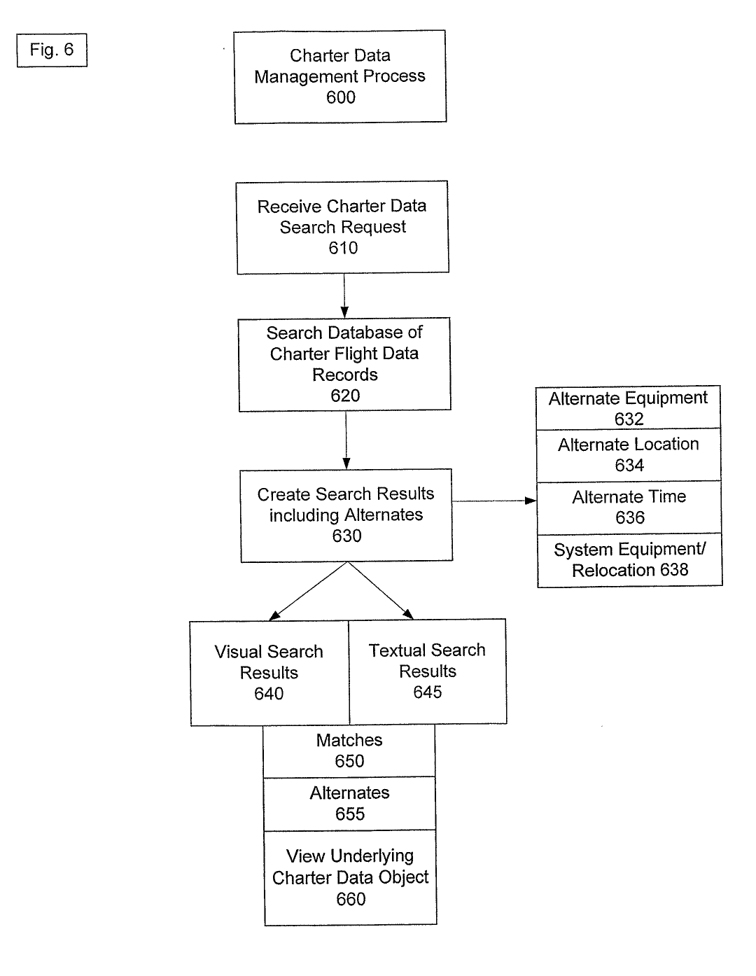

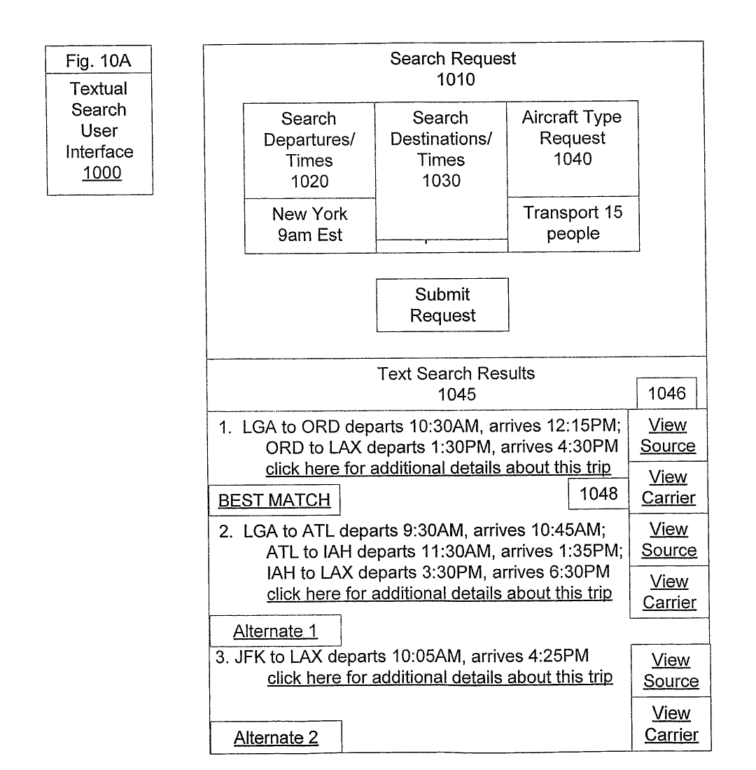

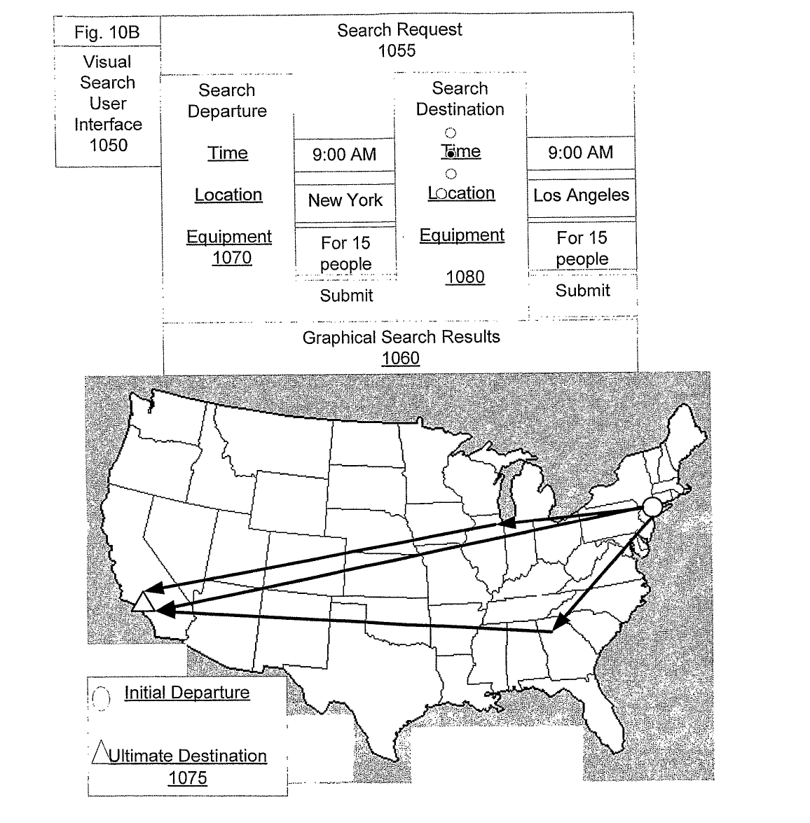

FIG. 6 is a high-level flow diagram illustrating aspects of the flight request processing according to an embodiment of the invention. The process is initiated when a system user accesses the system and creates a charter data search request in step 610. In an implementation, the system user may log onto the system and utilize the visual/textual search request interface in order to create a search request (as illustrated in FIGS. 10A and 10B and discussed in greater detail below). Alternately, the system user may create a charter data search request and forward it to a service provider, who may in turn forward the request to the TAS system to check availability in step 610.

Once the search request is received, the system may process the search request to extract a search keyword for use in matching the request to an available flight record in step 620. Depending on the implementation, the system may use search request flight equipment characteristics, flight departure/destination location characteristics, flight departure/destination time characteristics to key the search of availability flight records. The TAS creates a search result listing identifying a best match, as well as ranked alternates to the best match. The alternates may be ranked according to alternate equipment parameters 632, alternate location parameters 634, alternate time parameters 636, or alternate equipment relocation parameters 638. The equipment relocation parameters 638 illustrate the additional cost that would be involved in relocating near-by equipment that could satisfy the search request parameters.

After logging onto the TAS in step 210, the system user interacts with the search engine 110 to generate and submit a search request. In step 220, the TAS receives the search request. The system generates and executes a system query, to determine whether there are any initial matches in step 230. In some embodiments of the invention, the system may also create and present alternate travel arrangements to the system user derived based on the initial query in step 240. In step 250, the system generates and displays the search results to the system user.

Based on the needs of a particular system user, some implementations of the TAS may be configured with certain capabilities such as processing a search request based on user and/or system defined search terms or user and/or system defined rules for suggesting alternate results. For example, depending on the needs of the user and/or the precision of the departing time requested and the region or airport requested, the system may be configured to determine certain number of possible calculations:
For a search request, aircrafts that are available are identified and matched with empty legs for the day and/or time of the request.
Check coverage:
   Estimate length of flight and flight time using the latitude and longitude of the airports
   Compare coverage minimum with flight time
Check for the aircrafts' real-time position to see if some could be repositioned to match the request:
   Using tail number, the system links the base airport and calculates the distance and time of flight to nearest airports.
   Verify areas of transits
   Calculate if repositioning time is less than 50% of the flight time between point A and point B
To find additional matches for possible new flight departures, the system looks at the destinations of future one-way flights.
The system matches round trip flight requests with two one ways flights. Alternately, the system may match two one ways flights with a request with a round trip.

The system may also be configured to support the following features:
Sales representatives may receive alerts of new matches found for requests that have been received and matched to possible availabilities so that can further decide the best match for the customer and get a quote from the company making the flight available.
Search results can be:
   Sorted by freshness of data
   Displayed from best location to the worst locations (closest matches)
   Filtered by range (distance) or time (hours)
   Filtered by region
   Displayed visually using a mapping engine
      Two possible implementations of search engine results are included and described in FIGS. 10A and 10B (detailed below). Furthermore, the system may be configured to maintain records of account information within a TAS database including: a list of companies and allows to list companies and view their details, including:
The type of aircrafts they have
Where they are based
Typical prices
Available flights from this company
Past activities with the company and satisfaction
   Moreover, the TAS's flexible Application Programming Interface (API) modules allow full integration with other software applications. For example, a CRM system might receive sales opportunities and send a request to the system, which will return results of possible flights availability. Some features of the API include capabilities to:
Retrieve, insert and modify aviation company data
Retrieve, insert and modify prospective flight requests
Synchronize companies, contacts, flight requests and available flight routes with external CRM systems
Initiate search for specific flight requests or flight availabilities and retrieve search results
Access the system to parse and understand unstructured flight information has it's own API which can be configured to fine-tune priorities of rules, add search and retrieval templates, add and modify keywords used, etc.

Visual indicators show the level of confidence for each displayed records when the records originate from unstructured information that the system could not identify with certainty. Aspects of these features are discussed in greater detail with regard to FIGS. 10A and 10B.

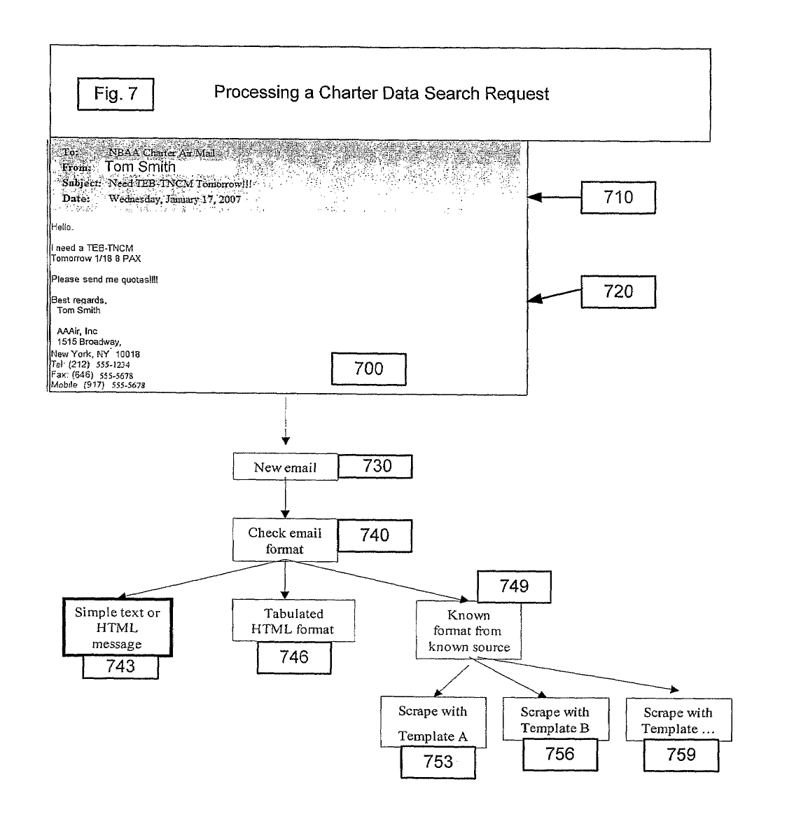

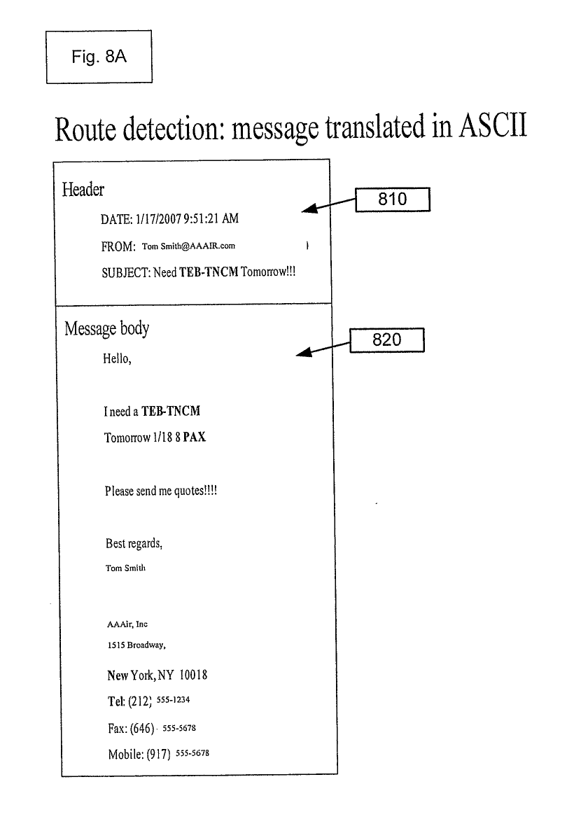

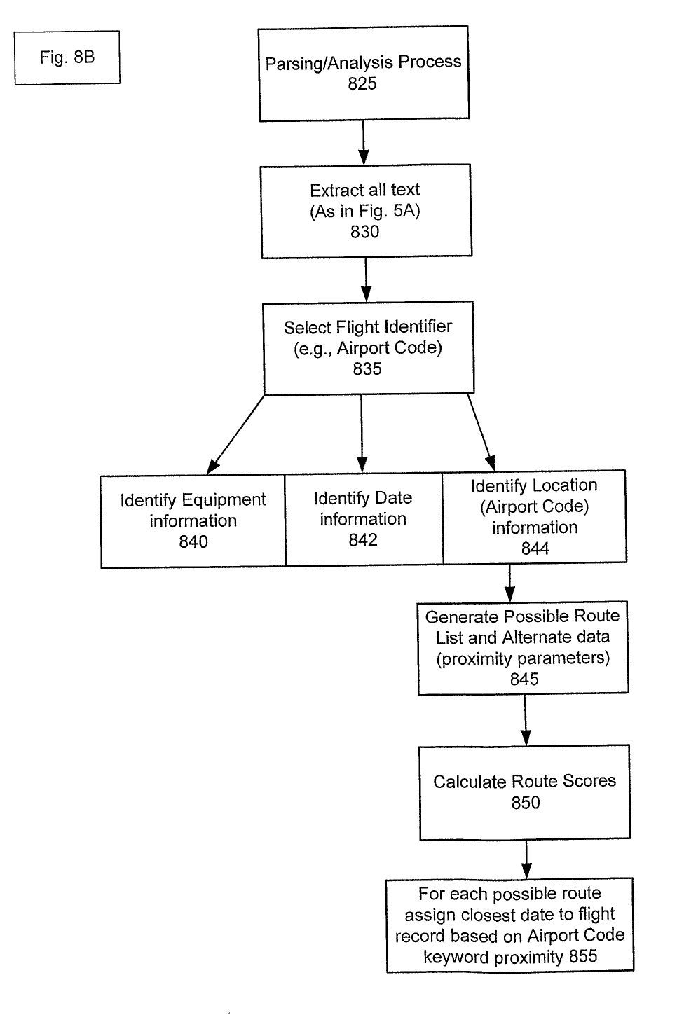

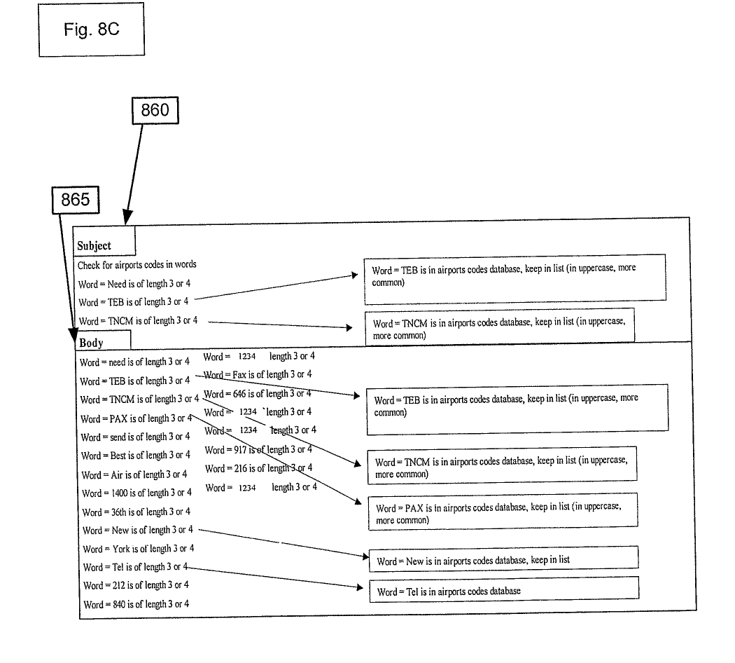

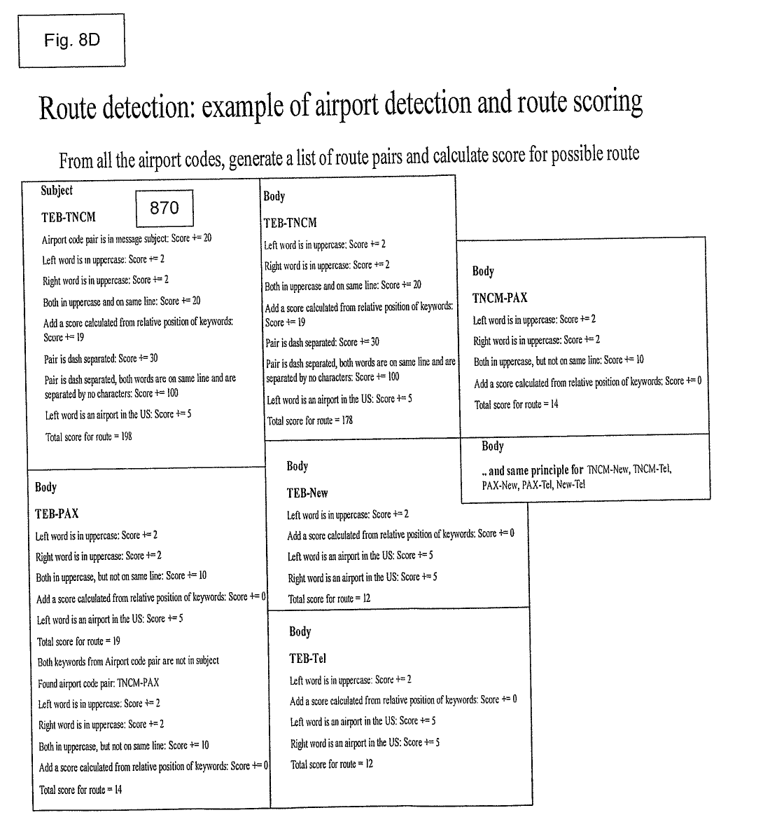

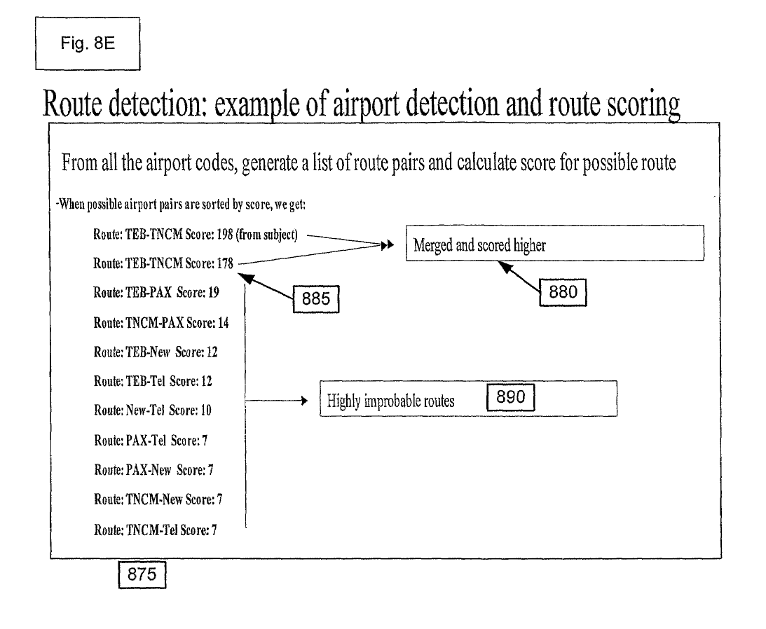

FIGS. 7 and 8A-8E illustrate aspects of the another method of processing a search request according to an implementation of the TAS, where a charter data search request is received by the system. FIG. 7 illustrates the charter data search request configured as an email with a header 710 and a body 720. The email search request process is similar to that discussed above regarding the charter data object processing illustrated in FIGS. 4-5E. The email is received by the TAS in step 730 and subsequently checks the email format in step 740. Depending on the format, the TAS may apply a different set of data extraction rules. For example, the email may be configured as simple text or an HTML message 743, a Tabulated HTML format 746 or a known format from a registered data source. If the search request is from a registered source, the TAS may be able to apply a corresponding source-specific parsing template (Template A 753, Template B 756, or Template X 759).

FIG. 8A illustrates the first step once the email format has been identified—the TAS extracts the raw text from the email for processing but maintains two distinct text portions for analysis—text from header 810 and text from body 820. Once the raw text is extracted, the TAS proceeds with formatting and parsing the text to extract possible flight identifiers as illustrated in FIG. 8B. The text parsing/analysis process 825 starts with dividing the raw text into the original object portions for parsing (e.g., header text remains in the header section 810 and body text remains in the body section 820). The partitions may be used later in the analysis to assist in determining the confidence metric.

The parsing tool identifies which keyword will serve as a flight identifier for the purposes of an analysis run in step 835. For the purposes of this discussion, the airport code 844 has been designated as the keyword flight indicator the parser will use to match with potential search results. It is to be understood however, that depending on the source/type of data object and/or the particular needs of a system user, the keyword flight indicator may be designated as date information (842), equipment information (840) or a number of other parameters that may appear in charter data objects. Based on the keyword flight indicator, the TAS then generates a possible matched route listing and extracts flight characteristics in step 845. In some implementations, the TAS uses word proximity as a correlation factor in matching flight characteristics with a flight indicator.

Once the listing is generated, each possible route is scored according to a scoring template associated with the charter data source/data object in step 850. Once the viable routes are identified, the flight date information and additional flight characteristics are associated with the indicator based on keyword proximity in step 855.

FIG. 8C illustrates an example of how the keyword identifier is parsed within the raw text for two portions of charter data search request. In FIG. 8C, the keyword identifier is a 3 or 4 letter word known as the airport code (every airport is associated with a unique airport code—for example LaGuardia Airport in New York city corresponds is designated “LGA”). Accordingly, all 3 or 4 letter words in the subject portion 560 and the body portion 565 of the charter object are identified as possible airport codes. As shown in FIG. 8C, the raw text “Need”, “TEB” and “TNCM” qualify as 3 or 4 letter words. These words may then be compared with the airport code database entries stored within the TAS system database.

FIG. 8D illustrates aspects of the airport code pairing and scoring process conducted to determine whether the charter object include viable charter flight route information. For example, each of the hits from the previous step (e.g., “TEB” or “TNCM”) is matched with another hit and contextually analyzed to determine a relative score for the proposed route. For example, in FIG. 8D “TEB” and “TNCM” are identified as a potential match and paired for further analysis as a subject pair 870. The scoring analysis is based on adding points to a net score if certain constraints are met.

For example, because the airport code pair is in message subject portion—the proposed route's score is increased by 20 points. Because each of the left word and the right word in the pair is in uppercase format independently, the route score is increased by 4 points. Furthermore, because both words in the pair are in uppercase and on the same line, the score is increased by an additional 20 points. Generally, the more indicative the characteristic is of an actual flight route, the more the score for the pair is increased. For example, because the pair is separated by a dash, both words are on the same line and there are no other characters separating the pair, the score is increased by 100 points. This feature is highly indicative of a viable route.

However, it is to be understood that although the figures are directed to an airport code scoring set, the TAS may be configured to implement scoring rules directed to analyze and score the raw text based on other key words related to equipment, departure/destination location, departure/destination time and/or other flight indicators.

FIG. 8E illustrates aspects of the scoring routine, wherein the score for each proposed pair identified in FIG. 8E is compared. The TAS creates a listing of all possible pairs and each pair's corresponding score 875. If a pair appears in both the subject and the body portions of the record, the pair scores are merged. For such pairs, the combined score 880 is used to determine whether the pair of indicators qualifies as viable flight data. Depending on the implementation and the scoring rules implemented by the TAS, there is a viability threshold 885 that is the effective cutoff for a pair to qualify as viable flight data. As illustrated in FIG. 8E, flights listed below the threshold are designated as highly improbable routes 890. The process may be automated with the system eliminating proposed routes that fall below the threshold. In the alternative, the viable route designation may be achieved visually by a system administrator once all of the routes have been scored. Furthermore, as part of a visual determination the system administrator may be provided with access to the underlying charter data search request to assist with their viability determination.

Furthermore, in some embodiments the TAS system may implement additional filters that exclude proposed pairs where the distance between airports is too short. Alternately, the score may be reduced or eliminated if the airport is too remote, a military airport, or not relevant for the requested/available flight equipment. Date detection may be accomplished by pattern matching, prioritizing patterns, or textual position relative to proposed routes.

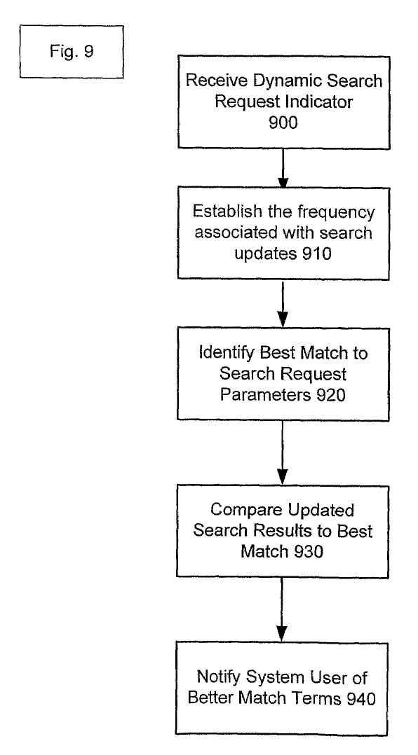

FIG. 9 is a flow diagram illustrating aspects of a dynamic search result update. Once the search request parameters have been extracting, the system conducts a search of the charter flight data records stored in the TAS database. The system generates a best match based on the system determined closes available flight data record. In an implementation of the invention, the system is configured to store the best match parameters and re-attempt the search requests to determine if a better match is found for a user-specified period of time. In FIG. 9, the TAS receives a dynamic search request indicator as part of the initial search request in step 900. The TAS then establishes the frequency of the periodic update—how often a search of available records is performed in step 910. Both of these parameters are generally included as part of the search request (alternately they may be established for a registered system user during the system user registration process. The system associates the search request with the system user's account information and stores the search request/results information in the system database. The TAS also stores a copy of the best match from the initial search in step 920. The specific parameters of the best match and the initial search request are then compared to the updated search results in step 930. If a better match is found, the TAS then notifies the system user of the terms associated with the better match in step 940.

Depending on the particular implementation, the new search results may be simply stored in the system database (in step 940) for review by a system user at a later time. Alternately, the system user (or administrator) may establish a set of comparison rules to only store the ‘best result’ from the periodic search updates. For example, the search request may define departure and destination cities, travel days, but may be optimized to keep the ‘best price’ result from the periodic searches for a user-determined length of time. The user may then access the periodic update storage modules to see if they would like to change/accept the new parameters, instead of the previous ‘best’ search result parameters. Alternately the system may be configured to update the stored ‘best’ results and generate and transmit a user alert to notify the user of the updated search results, as in the step 940.

FIG. 10A illustrates a user interface 1000 associated with the TAS. In FIG. 10A, the system user's search results are presented in a textual format for display to the user. In both embodiments, the search request form 1010 is an interactive form. More specifically, the system user can interact with the form to manually enter a departure city/time, in a text box under ‘Departures’ box 420. Alternately, the actual text “Search Departures” may be configured as a web link to a listing of possible departure cities/times. The system user would simply click on their respective departure city and the form would update the search request text box with the corresponding departure information. “Search Destinations/Times” element 1030 may be configured in a similar fashion. The search criteria may also include a wide variety of other search parameters including aircraft type request or an equipment request based on the number of people who need transport 1040.

After the system user has defined the search criteria, the user clicks on the submit request button. The system then generates and displays the search results in a text-based listing 1045. For example, FIG. 10A illustrates three search results from the search request looking for flights from New York to Los Angeles: 1. New York (LGA) to Chicago (ORD) and then to Los Angeles (LAX); 2. New York (LGA) to Atlanta (ATL), then to Houston (IAH) and finally Los Angeles (LAX); and 3. a flight from New York (JFK) to Los Angeles (LAX). All three search results may be configured as links to web pages that contain additional details about the particular flight information when a user clicks on the respective link. Also, the display interface may include links to enable a system user to view the underlying source 1046 (e.g., flight data record or charter data object where the flight information was extracted from). Also, the interface may be configured to provide access to carrier information 1048, such as previous customer reviews and/or carrier equipment descriptions, rosters, base locations, etc. . . .

In contrast to the implementation illustrated in FIG. 10A, FIG. 10B generates a graphical initial representation of the search results. For example, the graphical search results 1060 may be generated over a map of the United States or customized for another travel area. As illustrated in FIG. 10B, the initial departure city is illustrated as a particular shape (e.g., a circle), whereas the ultimate destination is illustrated as a different shape (e.g., a triangle) 1075. Further, each leg of the trip may be configured as a clickable image (i.e., if a user clicks on the arrow between New York and Chicago, the flight/carrier data associated with that leg of the trip may be displayed). Alternately, the user may simply “mouse over” the arrow to display a text box with the corresponding flight/carrier information. The display may include a legend 1075 that describes the elements generally or in some embodiments the legend 1075 may be customized to illustrate the specific elements for a particular search result (e.g., a specific search result—LGA->ORD->LAX). Also, the ‘best match’ may be displayed in a particular color that is different from the TAS suggested alternative data flight records. In an implementation of the TAS, aspects of the textual and visual user interfaces may be combined to achieve a hybrid search result display interface.

The system is customizable for a particular user and may include additional/alternate search fields. Search interfaces may be configured with the following filtering fields to look for alternative search results for one-way flights: Departure/Destination location and time may be changed by the user interacting with fields 1070, 1080. The TAS may be configured to provide suggested ‘alternate’ search results in addition to the ‘best match.’ These alternates may include the earliest possible departure and/or the latest possible arrival; different category of equipment (light jets, mid jets, heavy jets, airliners, etc.); multiple categories of planes can be searched at the same time; a user-defined radius of nearest available airplanes in nautical miles (or available in hours travel time). The system may be configured to: check for empty legs only or aircrafts that are arriving and departing; check for flight requests, available flights or both. The system user may designate a flight record freshness parameter in days and hours (related to recent activity). In some embodiments, search results are updated in real-time as the user changes the search parameters. The user can also sort the results according to a wide variety of parameters, including the recency of the data.

In addition to the implementation illustrated in FIG. 10B, the displayed search results can be displayed using a visual map showing one leg lines between two points, direction, type of source, where it is coming from, position of aircraft in real time with link to base. The system user may request a trip from point A to point B with system flight data record filtering capability by date, aircraft type, repositioning time. Each arrival and departure is shown using an icon that indicates the direction of the plane. Arrival and departure points can be clicked to show a pop-up window of the flight's details including: details of the airport represented by the icon, a list of prospective flight requests and the list of flights arriving and departing from the airport clicked. Each flight will show the date and time of departure and destination, phone number and email of contact, aircraft model, airports used in the route and the source of the flight's data. Hyperlinks can be used to consult the details of the airport or the details of each flight. Arrows representing prospective flight requests are displayed using dotted or solid lines with a certain color.

The system may be configured with a search interface includes the following filtering fields to identify available flights for selection as best match/alternate flight search results:
a. Departure airport, destination airport
b. Date and time of earliest possible departure and latest possible arrival
c. Category of plane (light jets, mid jets, heavy jets, airliners, etc.) Multiple categories of planes can be searched at the same time.
d. Radius of nearest available airplanes in nautical miles. Is also available in hours.
e. Check for empty legs only or aircrafts that are arriving and departing
f. Check for flight requests, available flights or both
g. Content freshness in days and hours

In an implementation, search results may be updated in real-time as the user changes the search parameters. The user can also sort the results from many different parameters, including the recency of the information. The displayed search results can be displayed using a visual map showing one leg lines between two points, direction, type of source, where it is coming from, position of aircraft in real time with link to base, request trip from point A to point B with filtering capability by date, aircraft type, repositioning time. Each arrival and departure is shown using an icon that indicates the direction of the plane. Arrival and departure points can be clicked to show a pop-up window of the flight's details including: details of the airport represented by the icon, a list of prospective flight requests and the list of flights arriving and departing from the airport clicked. Each flight will show the date and time of departure and destination, phone number and email of contact, aircraft model, airports used in the route and the source of the flight's data. Hyperlinks can be used to consult the details of the airport or the details of each flight. Also, arrows representing prospective flight requests may be displayed using dotted lines.

In the visual search result embodiment, available one-way flights may be listed using a detailed results grid that can be sorted using the previously defined parameters. Visual indicators may also be included to display: the level of confidence for each flight data record, carrier information associated with the flight data record, and/or underlying charter data object for the extracted flight data record. Visual indicators show the level of confidence for each displayed records when the records originate from unstructured information that the system could not identify with certainty. In other embodiments, the visual display may include differ pictograms used for different type of equipment. Another grid may be included for displaying search results for prospective flight requests. The user interfaces and TAS system can also be adapted to search for other types of flights: round-trips, multiple legs, etc. Moreover, the TAS could also suggest multiple legs for a one-leg request if the route can be constructed for the same initial departure and final destination (as illustrated in FIG. 10B with the multiple one-leg trip from New York to Los Angeles),

### Travel Aggregation System (TAS) Controller

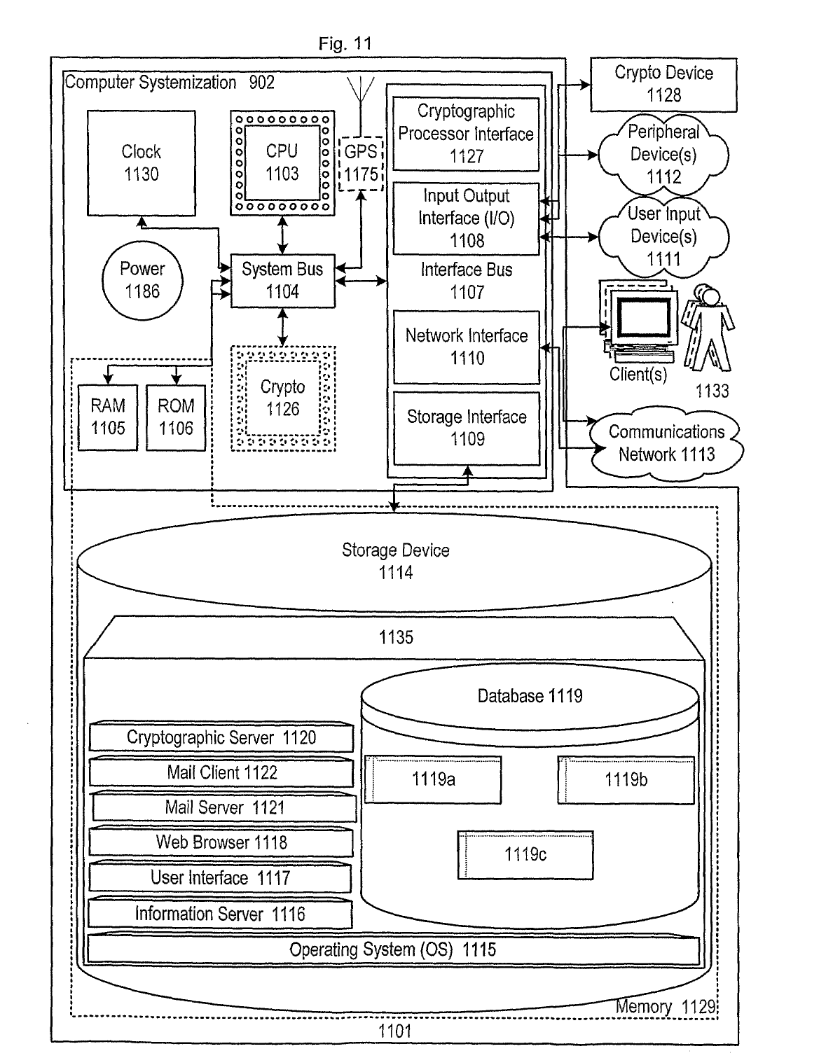

The travel aggregation system described above may be embodied by a travel aggregation system (TAS) controller 1101. FIG. 11 of the present disclosure illustrates inventive aspects of the TAS controller 1101 in a block diagram. In this embodiment, the TAS controller 1101 may serve to obtain/receive, process charter data objects, create charter data records, and facilitate charter data record management and search functionality.

Computers employ processors to process information; such processors are often referred to as central processing units (CPU). A common form of processor is referred to as a microprocessor. A computer operating system, which, typically, is software executed by CPU on a computer, enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through database software. Information technology systems provide interfaces that allow users to access and operate various system components.

In one embodiment, the TAS controller 1101 may be connected to and/or communicate with entities such as, but not limited to: one or more users from user input devices 1111; peripheral devices 1112; a cryptographic processor device 1128; and/or a communications network 1113.

Networks are commonly thought to comprise the interconnection and interoperation of clients, servers, and intermediary nodes in a graph topology. It should be noted that the term “server” as used throughout this disclosure refers generally to a computer, other device, software, or combination thereof that processes and responds to the requests of remote users across a communications network. Servers serve their information to requesting “clients.” The term “client” as used herein refers generally to a computer, other device, software, or combination thereof that is capable of processing and making requests and obtaining and processing any responses from servers across a communications network. A computer, other device, software, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The TAS controller 1101 may be based on computer systems that may comprise, but are not limited to, components such as: a computer systemization 1102 connected to memory 1129.

### Computer Systemization

A computer systemization 1102 may comprise a clock 1130, central processing unit (CPU) 1103, a read only memory (ROM) 1106, a random access memory (RAM) 1105, and/or an interface bus 1107, and most frequently, although not necessarily, are all interconnected and/or communicating through a system bus 1104. Optionally, the computer systemization may be connected to an internal power source 1186. Optionally, a cryptographic processor 1126 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program modules for executing user and/or system-generated requests. The CPU may be a microprocessor such as AMD's Athlon, Duron and/or Opteron; IBM and/or Motorola's PowerPC; Intel's Celeron, Itanium, Pentium, Xeon, and/or XScale; and/or the like processor(s). The CPU interacts with memory through signal passing through conductive conduits to execute stored program code according to conventional data processing techniques. Such signal passing facilitates communication within the TAS controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

### Power Source

The power source 1186 may be of any standard form for powering small electronic circuit board devices such as the following power cells: alkaline, lithium hydride, lithium ion, nickel cadmium, solar cells, and/or the like. Other types of AC or DC power sources may be used as well. In the case of solar cells, in one embodiment, the case provides an aperture through which the solar cell may capture photonic energy. The power cell 1186 is connected to at least one of the interconnected subsequent components of the TAS thereby providing an electric current to all subsequent components. In one example, the power source 1186 is connected to the system bus component 1104. In an alternative embodiment, an outside power source 1186 is provided through a connection across the I/O 1108 interface. For example, a USB and/or IEEE 1394 connection carries both data and power across the connection and is therefore a suitable source of power.

### Interface Adapters

Interface bus(ses) 1107 may accept, connect, and/or communicate to a number of interface adapters, conventionally although not necessarily in the form of adapter cards, such as but not limited to: input output interfaces (I/O) 1108, storage interfaces 1109, network interfaces 1110, and/or the like. Optionally, cryptographic processor interfaces 1127 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1109 may accept, communicate, and/or connect to a number of storage devices such as, but not limited to: storage devices 1114, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1110 may accept, communicate, and/or connect to a communications network 1113. Through a communications network 1113, the TAS controller is accessible through remote clients (e.g., computers with web browsers) by users 1133. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1110 may be used to engage with various communications network types 1113. For example, multiple network interfaces may be employed to allow for the communication over broadcast, multicast, and/or unicast networks.

Input Output interfaces (I/O) 1108 may accept, communicate, and/or connect to user input devices 1111, peripheral devices 1112, cryptographic processor devices 1128, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 1111 may be card readers, dongles, finger print readers, gloves, graphics tablets, joysticks, keyboards, mouse (mice), remote controls, retina readers, trackballs, trackpads, and/or the like.

Peripheral devices 1112 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the TAS controller may be embodied as an embedded, dedicated, and/or monitor-less (i.e., headless) device, wherein access would be provided over a network interface connection.

Cryptographic units such as, but not limited to, microcontrollers, processors 1126, interfaces 1127, and/or devices 1128 may be attached, and/or communicate with the TAS controller. A MC68HCI16 microcontroller, commonly manufactured by Motorola Inc., may be used for and/or within cryptographic units. Equivalent microcontrollers and/or processors may also be used. The MC68HCI6 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 740 MHz Roadrunner.

### Memory

Generally, any mechanization and/or embodiment allowing a processor to affect the storage and/or retrieval of information is regarded as memory 1129. However, memory is a fungible technology and resource, thus, any number of memory embodiments may be employed in lieu of or in concert with one another. It is to be understood that the TAS controller and/or a computer systemization may employ various forms of memory 1129. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1129 will include ROM 06, RAM 05, and a storage device 1114. A storage device 1114 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); and/or other devices of the like. Thus, a computer systemization generally requires and makes use of memory.

### Module Collection

The memory 1129 may contain a collection of program and/or database modules and/or data such as, but not limited to: operating system module(s) 1115 (operating system); information server module(s) 1116 (information server); user interface module(s) 1117 (user interface); Web browser module(s) 1118 (Web browser); database(s) 1119; cryptographic server module(s) 1120 (cryptographic server); the TAS module(s) 1135; and/or the like (i.e., collectively a module collection). These modules may be stored and accessed from the storage devices and/or from storage devices accessible through an interface bus. Although non-conventional software modules such as those in the module collection, typically, are stored in a local storage device 1114, they may also be loaded and/or stored in memory such as: peripheral devices, RAM, remote storage facilities through a communications network, ROM, various forms of memory, and/or the like.

### Operating System

The operating system module 1115 is executable program code facilitating the operation of the TAS controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, Windows Server 2000/2003 and/or the like operating systems. However, more limited and/or less secure operating systems also may be employed such as Apple Macintosh OS, Microsoft DOS, Palm OS, Windows 2000/3.1/95/98/CE/Millennium/NT/XP/Vista and/or the like. An operating system may communicate to and/or with other modules in a module collection, including itself, and/or the like. Most frequently, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. The operating system may provide communications protocols that allow the TAS controller to communicate with other entities through a communications network 1113. Various communication protocols may be used by the TAS controller as a subcarrier transport mechanism for interaction, such as, but not limited to: multicast, TCP/IP, UDP, unicast, and/or the like.

### Information Server

An information server module 1116 is stored program code that is executed by the CPU. The information server may be a conventional Internet information server such as, but not limited to Apache Software Foundation's Apache, Microsoft's Internet Information Server, and/or the. The information server may allow for the execution of program modules through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program modules. After a Domain Name System (DNS) resolution portion of an HTTP request is resolved to a particular information server, the information server resolves requests for information at specified locations on the TAS controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 721, and/or the like. An information server may communicate to and/or with other modules in a module collection, including itself, and/or facilities of the like. Most frequently, the information server communicates with the TAS database 1119, operating systems, other program modules, user interfaces, Web browsers, and/or the like.

Access to the TAS database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the TAS. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the TAS as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program module, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface module 1117 is stored program code that is executed by the CPU. The user interface may be a conventional graphic user interface as provided by, with, and/or atop operating systems and/or operating environments such as Apple Macintosh OS, e.g., Aqua, Microsoft Windows (NT/XP), Unix X Windows (KDE, Gnome, and/or the like), mythTV, and/or the like. The user interface may allow for the display, execution, interaction, manipulation, and/or operation of program modules and/or system facilities through textual and/or graphical facilities. The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

### Web Browser

A Web browser module 1118 is stored program code that is executed by the CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program modules through facilities such as Java, JavaScript, ActiveX, and/or the like. Web browsers and like information access tools may be integrated into PDAs, cellular telephones, and/or other mobile devices. A Web browser may communicate to and/or with other modules in a module collection, including itself, and/or facilities of the like. Most frequently, the Web browser communicates with information servers, operating systems, integrated program modules (e.g., plug-ins), and/or the like; e.g., it may contain, communicate, generate, obtain, and/or provide program module, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the TAS enabled nodes. The combined application may be nugatory on systems employing standard Web browsers.

### Cryptographic Server

A cryptographic server module 1120 is stored program code that is executed by the CPU 1103, cryptographic processor 1126, cryptographic processor interface 1127, cryptographic processor device 1128, and/or the like. Cryptographic processor interfaces will allow for expedition of encryption and/or decryption requests by the cryptographic module; however, the cryptographic module, alternatively, may run on a conventional CPU. The cryptographic module allows for the encryption and/or decryption of provided data. The cryptographic module allows for both symmetric and asymmetric (e.g., Pretty Good Protection (PGP)) encryption and/or decryption. The cryptographic module may employ cryptographic techniques such as, but not limited to: digital certificates (e.g., X.509 authentication framework), digital signatures, dual signatures, enveloping, password access protection, public key management, and/or the like. The cryptographic module will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the TAS controller may encrypt all incoming and/or outgoing communications and may serve as node within a virtual private network (VPN) with a wider communications network. The cryptographic module facilitates the process of “security authorization” whereby access to a resource is inhibited by a security protocol wherein the cryptographic module effects authorized access to the secured resource. In addition, the cryptographic module may provide unique identifiers of content, e.g., employing and MD5 hash to obtain a unique signature for an digital audio file. A cryptographic module may communicate to and/or with other modules in a module collection, including itself, and/or facilities of the like. The cryptographic module supports encryption schemes allowing for the secure transmission of information across a communications network to enable the TAS module to engage in secure transactions if so desired. The cryptographic module facilitates the secure accessing of resources on the TAS and facilitates the access of secured resources on remote systems; i.e., it may act as a client and/or server of secured resources. Most frequently, the cryptographic module communicates with information servers, operating systems, other program modules, and/or the like. The cryptographic module may contain, communicate, generate, obtain, and/or provide program module, system, user, and/or data communications, requests, and/or responses.

### The TAS Database

The TAS database module 1119 may be embodied in a database and its stored data. The database is stored program code, which is executed by the CPU; the stored program code portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. MQre precisely, they uniquely identify rows of a table on the “one” side of a one-to-many relationship.

Alternatively, the TAS database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the TAS database is implemented as a data-structure, the use of the TAS database 1119 may be integrated into another module such as the TAS module 1135. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database module 1119 includes several tables 1119a-c. A charter data object source table 1119a includes fields such as, but not limited to: source ID, preferred formatting information, corresponding parsing rules, and/or carrier information, and/or the like. A charter data extraction tool set table 1119b includes fields such as, but not limited to: parsing priority, charter indicator information, charter characteristic information, scoring rule sets, and/or the like. An dynamic search update table 1119c includes fields such as, but not limited to: best match search result, update frequency data, initial search request parameters, alternate search result parameters, and/or the like.

In one embodiment, the TAS database may interact with other database systems. For example, employing a distributed database system, queries and data access by the TAS modules may treat the combination of the TAS and TAS database as a single database entity.

In one embodiment, user programs may contain various user interface primitives, which may serve to update the TAS. Also, various accounts may require custom database tables depending upon the environments and the types of clients the TAS may need to serve. It should be noted that any unique fields may be designated as a key field throughout. In an alternative embodiment, these tables have been decentralized into their own databases and their respective database controllers (i.e., individual database controllers for each of the above tables). Employing data processing techniques, one may further distribute the databases over several computer systemizations and/or storage devices. Similarly, configurations of the decentralized database controllers may be varied by consolidating and/or distributing the various database modules 1119a-c. The TAS may be configured to keep track of various settings, inputs, and parameters via database controllers.

The TAS database may communicate to and/or with other modules in a module collection, including itself, and/or facilities of the like. Most frequently, the TAS database communicates with the TAS module, other program modules, and/or the like. The database may contain, retain, and provide information regarding other nodes and data.

### The TAS Control Module

The TAS module 1135 is stored program code that is executed by the CPU. The TAS control module affects accessing, obtaining and the provision of information, services, transactions, and/or the like across various communications networks.

The TAS module enables access of information between nodes and may be developed by employing standard development tools such as, but not limited to: (ANSI) (Objective-) C (++), Apache modules, binary executables, database adapters, Java, JavaScript, mapping tools, procedural and object oriented development tools, PERL, Python, shell scrip ts, SQL commands, web application server extensions, WebObjects, and/or the like. In one embodiment, the TAS server employs a cryptographic server to encrypt and decrypt communications. The TAS module may communicate to and/or with other modules in a module collection, including itself, and/or facilities of the like. Most frequently, the TAS module communicates with the TAS database, operating systems, other program modules, and/or the like. The TAS may contain, communicate, generate, obtain, and/or provide program module, system, user, and/or data communications, requests, and/or responses.

### Distributed TAS

The structure and/or operation of any of the TAS node controller components may be combined, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data-processing techniques. Furthermore, single instances may also be distributed across multiple controllers and/or storage devices; e.g., databases. All program module instances and controllers working in concert may do so through standard data processing communication techniques.

The configuration of the TAS controller will depend on the context of system deployment. Factors such as, but not limited to, the budget, capacity, location, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If module collection components are discrete, separate, and/or external to one another, then communicating, obtaining, and/or providing data with and/or to other module components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete module components for inter-application communication or within memory spaces of a singular module for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between modules. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

We claim:

1. A method for charter data management comprising:
processing a charter data object from a charter data source;
identifying a charter data indicator included within the charter data object;
creating and populating an available flight data record based on the charter data indicator and corresponding supplemental flight characteristics;
deriving a confidence indicator based on the type of identified charter data indicator and charter data source associated with the charter data object.

2. The method of claim 1, wherein the charter data object is obtained from a charter data source through active charter data object location.

3. The method of claim 2, wherein the active data location includes searching predetermined web sites to the extract the charter data object.

4. The method of claim 1, wherein the charter data object is obtained through passive data location.

5. The method of claim 4, wherein the passive data location involves subscribing to a charter data email list server and receiving charter data objects configured as email.

6. The method of claim 1, wherein the charter data source is a registered data source.

7. The method of claim 1, wherein the charter data source is a non-registered charter data source.

8. The method of claim 1, further comprising:
correlating the charter data indicator to a departure or destination location data.

9. The method of claim 8, further comprising:
the charter data indicator is configured as an airport code.

10. The method of claim 1, further comprising:
correlating the charter data indicator to departure or destination time data.

11. The method of claim 1, further comprising:
correlating the charter data indicator to carrier equipment data.

12. A method for managing processed charter data comprising:
receiving a charter data search request;
identifying a charter indicator within the charter data search request;
processing the charter data search request to derive charter location, time and equipment request information;
correlating the processed request information to available charter data from a flight data record as initial search results; and
displaying a best match result to the search request and alternates to the best match.

13. The method of claim 12, further comprising;
receiving a dynamic periodic search result update indicator;
storing the best match result parameters and the search request parameters;
subsequently periodically re-correlating the processed request information to available charter data from a flight data record as secondary search results;
comparing the initial search results with the secondary search results;
notifying a system user is the secondary search results are determined as a closer match than the initial search results.

14. The method of claim 12, wherein the charter data search request is configured as a visual-based charter data search request.

15. The method of claim 12, wherein the charter data search request is configured as a textual based charter data search request;

16. The method of claim 15, wherein the textual based charter data search request is a non-structured request document.

17. The method of claim 16, wherein the non-structured request document is configured as an email.

18. The method of claim 12, wherein the correlation process includes identifying alternates for the identified best match based on available equipment.

19. The method of claim 12, wherein the correlation process includes identifying alternates for the identified best match based on available destination or departure times.

20. The method of claim 12, wherein the correlation process includes identifying alternates for the identified best match based on available destination or departure location.

21. The method of claim 12, wherein the correlation process includes identifying alternates for the identified best match based on equipment that may be relocated to create improved match results.

22. A system for charter data management comprising:
a processor;
a memory in communication with the processor and containing program instructions;
an input and output in communication with the processor and memory;
wherein the processor executes program instructions contained in the memory and the program instructions comprise:
processing a charter data object from a charter data source;
identifying a charter data indicator included within the charter data object;
creating and populating an available flight data record based on the charter data indicator and corresponding supplemental flight characteristics; and
deriving a confidence indicator based on the type of identified charter data indicator and charter data source associated with the charter data object.

23. The system of claim 22, wherein the charter data object is obtained from a charter data source through active charter data object location.

24. The system of claim 23, wherein the active data location includes searching predetermined web sites to the extract the charter data object.

25. The system of claim 22, wherein the charter data object is obtained through passive data location.

26. The system of claim 25, wherein the passive data location involves subscribing to a charter data email list server and receiving charter data objects configured as email.

27. The system of claim 22, wherein the charter-data source is a registered data source.

28. The system of claim 22, wherein the charter data source is a non-registered charter data source.

29. The system of claim 22, wherein the processor also executes program instructions for:
correlating the charter data indicator to a departure or destination location data.

30. The system of claim 29, wherein the processor also executes program instructions for:
the charter data indicator is configured as an airport code.

31. The system of claim 22, wherein the processor also executes program instructions for:
correlating the charter data indicator to departure or destination time data.

32. The system of claim 22, wherein the processor also executes program instructions for:
correlating the charter data indicator to carrier equipment data.

33. A system for managing processed charter data comprising;
a memory in communication with the processor and containing program instructions;
an input and output in communication with the processor and memory;
wherein the processor executes program instructions contained in the memory and the program instructions comprise:
receiving a charter data search request;
identifying a charter indicator within the charter data search request;
processing the charter data search request to derive charter location, time and equipment request information;
correlating the processed request information to available charter data from a flight data record as initial search results; and
displaying a best match result to the search request and alternates to the best match.

34. The system of claim 33, wherein the processor also executes program instructions for:
receiving a dynamic periodic search result update indicator;
storing the best match result parameters and the search request parameters;
subsequently periodically re-correlating the processed request information to available charter data from a flight data record as secondary search results;
comparing the initial search results with the secondary search results;
notifying a system user is the secondary search results are determined as a closer match than the initial search results.

35. The system of claim 33, wherein the charter data search request is configured as a visual-based charter data search request.

36. The system of claim 33, wherein the charter data search request is configured as a textual based charter data search request;

37. The system of claim 36, wherein the textual based charter data search request is a non-structured request document.

38. The system of claim 37, wherein the non-structured request document is configured as an email.

39. The system of claim 33, wherein the correlation process includes identifying alternates for the identified best match based on available equipment.

40. The system of claim 33, wherein the correlation process includes identifying alternates for the identified best match based on available destination or departure times.

41. The system of claim 33, wherein the correlation process includes identifying alternates for the identified best match based on available destination or departure location.

42. The system of claim 33, wherein the correlation process includes identifying alternates for the identified best match based on equipment that may be relocated to create improved match results.
